(19) United States
(12) Patent Application Publication
(10) Pub. No.: US 2025/0160250 A1
(43) Pub. Date: May 22, 2025

(54) PARTICULATE FLOW MONITORING APPARATUS FOR AN AGRICULTURAL MACHINE

(71) Applicant: Craig Lane Miller, Swan River (CA)

(72) Inventor: Craig Lane Miller, Swan River (CA)

(21) Appl. No.: 18/956,276

(22) Filed: Nov. 22, 2024

Related U.S. Application Data
(60) Provisional application No. 63/602,184, filed on Nov. 22, 2023.

(51) Int. Cl. A01D 41/127

(52) U.S. Cl. CPC A01D 41/1272

(57) ABSTRACT

An agricultural machine monitoring apparatus includes an x-ray imaging device generates x-ray images of particulate materials flowing through the agricultural machine and a controller arranged to process the x-ray images interested particles such as desirable particles within a waste flow or non-desirable particles within clean grain flow for example. The controller also calculates a numerical value representing an amount of the interested particles for display to an operator, for example grain, seeds, waste material or debris, which can be counted with a high degree of accuracy. In a harvester, the apparatus can be used for an accurate measure of yield, or an accurate measure of grain loss in various waste flows. In a seeding implement, the monitoring apparatus can be used to confirm that seed and/or fertilizer is properly flowing within pneumatic distribution lines.

This application claims the benefit under 35 U.S.C. 119 (e) of U.S. provisional application Ser. No. 63/602,184, filed Nov. 22, 2023.

### FIELD OF THE INVENTION

The present invention relates to a monitoring apparatus for an agricultural machine, and more particularly the present relates to a monitoring apparatus arranged to monitor flowable particulate materials flowing through the agricultural machine including grain, seed, fertilizer, and/or waste materials, for example for determining grain lost in waste flows of a harvesting machine and/or waste material within clean grain flow(s) of the harvesting machine or for monitoring flows in pneumatic distribution lines of a seeding implement.

### BACKGROUND

In the instance of an agricultural combine harvester, it is known to be desirable to monitor various aspects of the operation of the combine harvester such as some form of yield monitor that estimates the yield of grain being harvested or a loss monitor that estimates a number of lost seeds in the waste flows discharged from the harvester. The most common types of yield monitors rely on estimating the mass or volume of clean grain directed into the grain tank of the harvester. Such yield monitors are not able to distinguish between grain and non-grain particles within the cleaned grain flow such that the calculated yield may be inaccurate. Furthermore, such yield monitors are not suited for determining grain lost within other flows discharged from the harvesting machine as waste. Known loss monitors for monitoring grain lost in waste flows typically rely on grains impacting a sensor plate, however, such sensors are known to not be very accurate in their measurement.

United States Patent Application Publication No. US 2015/0009328 by Escher et al discloses an agricultural harvesting machine including an optical imaging device that captures images of the cleaned grain flow conveyed by the clean grain elevator into the grain tank of the harvesting machine. The optical imaging device generates optical images that can be processed to identify grain particles, damaged grain particles, and non-grain particles. The optical imaging device may have difficulty in distinguishing boundaries between multiple grains of similar color and texture in close proximity to one another leading to errors in estimating the yield calculation.

### SUMMARY OF THE INVENTION

According to one aspect of the invention there is provided a monitoring apparatus for an agricultural machine for handling flowable particulate materials, the apparatus comprising:
an x-ray imaging device arranged to be supported on the agricultural machine in proximity to a flow of the particulate materials passing through the agricultural machine, the x-ray imaging device including (i) an x-ray emitter arranged to emit electromagnetic radiation through the particulate materials from the flow, and (ii) an x-ray detector arranged to capture the electromagnet radiation emitted through the particulate materials from the flow by the x-ray emitter for generating x-ray images of the particulate materials from the flow; and
a controller in communication with the x-ray imaging device, the controller comprising a memory storing programming instructions thereon and a processor arranged to execute the programing instructions so as to be arranged to (i) process the x-ray images from the x-ray imaging device to identify interested particles comprising desirable particles or non-desirable particles within the particulate materials of the flow, (ii) calculate a numerical value representing an amount of the interested particles identified in the particulate materials of the flow, and (iii) display the numerical value to an operator of the agricultural machine.

According to a second aspect of the present invention there is provided a method of monitoring an agricultural machine arranged to harvest grain from an agricultural field, the method comprising:
providing an x-ray imaging device supported on the harvesting machine in proximity to a flow of harvested materials passing through the harvesting machine in which the x-ray imaging device includes (i) an x-ray emitter and an x-ray detector;
operating the x-ray imaging device to generate x-ray images as a time-series set of x-ray images of the flow of harvested materials by emitting electromagnetic radiation through the flow of harvested materials with the x-ray emitter and capturing the electromagnet radiation emitted through the flow of harvested materials with the x-ray detector; and
using a computer controller, (i) processing the x-ray images from the x-ray imaging device to identify grain particles or non-grain particles, (ii) calculating a numerical value representing an amount of the particles identified in the flow of harvested materials, (iii) displaying the numerical value to an operator of the harvesting machine.

The use of an x-ray imaging device that can be operatively associated with various flows of material through an agricultural machine, for example a harvester or a seeding implement, together with a controller for processing the resulting x-ray images, enables desirable and non-desirable particles to be identified and counted with a high degree of accuracy, for example grain, seeds, waste material or debris.

In a harvester, the monitoring apparatus is thus well suited for identifying grain within the cleaned grain flow to determine yield, as well as being suited for identifying grain within waste flows to determine grain loss of the harvesting machine. The adaptability of the x-ray imaging device to identify and count grain and/or non-grain particles within various flows further enables monitoring of the separation efficiency of the thresher and the sieves of the grain cleaner so that an operator can suitably adjust the operation of the harvester to minimize grain lost in waste flows of the harvesting machine.

In a seeding implement, the monitoring apparatus can be used to confirm that seed and/or fertilizer is properly flowing within pneumatic distribution lines and to provide feedback to the controller of the seeding implement for more accurately adjusting the metering of the seed and/or fertilizer as may be desired.

The controller may be arranged to identify the particles in the x-ray images (i) using contrast changes to define object boundaries and comparing similarity between shapes of the object boundaries and predetermined particle shapes stored on the controller, the predetermined particle shapes being representative of known particle types, and/or (ii) by comparing density patterns in the x-ray images to predetermined density patterns stored on the controller, the predetermined density patterns being representative of known particle types.

The agricultural machine may comprise an agricultural harvester in which the flow of the particulate material comprises a flow of harvested materials including grain and waste materials, wherein the controller is arranged to process the x-ray images such that the desirable particles comprise grain particles and the non-desirable particles comprise non-grain particles.

The x-ray imaging device may be arranged to be supported on the agricultural machine such that the flow of the particulate materials comprises a separated flow of the waste materials separated from the grain, and wherein the controller is arranged to identify the desirable particles in the separated flow such that the numerical value represents the amount of desirable particles lost in the separated flow. The separated flow may comprise (i) a tailings flow separated from a lower sieve of a grain cleaner of the agricultural machine, (ii) a thresher waste flow separated from a thresher of the agricultural machine, (iii) a cleaner waste flow separated from an upper sieve of a grain cleaner of the agricultural machine, or (vi) a combined waste flow including both a thresher waste flow separated from a thresher of the agricultural machine and a cleaner waste flow separated from an upper sieve of a grain cleaner of the agricultural machine. The controller may be arranged to acquire a yield value from the agricultural machine and calculate grain loss as a ratio between the numerical value of grain particles and the yield value from the agricultural machine.

The x-ray imaging device may be arranged to be supported on the agricultural machine such that the flow of the particulate materials further includes a clean grain flow of cleaned grain from which waste materials have been separated such that the controller is arranged to calculate a yield value representing harvested grain, and calculate grain loss as a ratio between the numerical value of grain particles in the separated flow and the yield value calculated by the controller to represent the harvested grain.

The x-ray imaging device may be arranged to be supported on the agricultural machine such that the flow of the particulate materials includes a feeder flow of the particulate materials from a feeder of the agricultural machine such that the controller is arranged to calculate a harvested value representing harvested grain and calculate grain loss as a ratio between the numerical value of grain particles in the separated flow and the harvested value calculated by the controller to represent the harvested grain in the feeder flow.

The x-ray imaging device may be arranged to be supported on the agricultural machine such that the flow of the particulate materials comprises a clean grain flow of cleaned grain from which waste materials have been separated, in which the controller is arranged to identify the grain particles in the clean grain flow such that the numerical value represents an observed yield value of the agricultural machine. The controller may also be arranged to (i) acquire a calculated yield value from the agricultural machine and (ii) calculate a similarity between the observe yield value and the calculated yield value from the agricultural machine.

The x-ray imaging device may be arranged to be supported on the agricultural machine such that the flow of the particulate materials comprises a feeder flow of the particulate materials from a feeder of the agricultural machine, in which the controller is arranged to identify the grain particles in the feeder flow such that the numerical value represents a harvested yield value of the agricultural machine. The x-ray imaging device may also be arranged to be supported on the agricultural machine such that the flow of the particulate materials further includes a clean grain flow of cleaned grain from which waste materials have been separated in which the controller is arranged to identify the grain particles in the clean grain flow and calculate a second numerical value that represents a clean grain yield value of the agricultural machine, and in which the controller is further arranged to calculate grain loss as a difference between the harvested yield value and the clean grain yield value. The x-ray imaging device may be further arranged to be supported on the agricultural machine such that the flow of the particulate materials further includes a separated flow of waste materials separated from harvested grain in which the controller is arranged to identify the grain particles in the separated flow and calculate a second numerical value that represents an amount of lost grain particles in the separated flow, and in which the controller is further arranged to calculate grain loss as a ratio of the amount of lost grain particles to the harvested yield value.

The x-ray imaging device may be arranged to be supported on the agricultural machine such that the flow of the particulate materials comprises a clean grain flow of cleaned grain from which waste materials have been separated, in which the controller is arranged to identify the non-grain particles in the clean grain flow such that the numerical value represents the amount of non-grain particles remaining in the clean grain flow. The controller may be further arranged to (i) identify the grain particles in the clean grain flow and calculate a yield value representing the amount of grain particles in the clean grain flow and (ii) calculate a dockage percentage as a ratio of said numerical value relative to said yield value.

The x-ray imaging device may be arranged to be supported on the agricultural harvester such that the flow of the particulate materials includes a feeder flow of the particulate materials from a feeder of the agricultural harvester in which the controller includes debris criteria stored thereon, and in which the controller is further arranged to identify debris objects in the feeder flow by applying the debris criteria to the x-ray images being processed. The apparatus may further include an ejection device arranged to eject the debris objects from the feeder flow, in which the controller is arranged to operate the ejection device to eject the debris objects from the feeder flow responsive to detection of the debris objects by the controller.

When the agricultural machine includes an existing flow sensor arranged to measure a flow value representative of a number of the desired particles in the flow of the particulate materials, the controller may be arranged to (i) acquire the flow value from the existing flow sensor, (ii) process the x-ray images to count a number of the desired particles in the x-ray images, and (iii) calculate a correction value based on the flow value and the number of the desired particles counted in the x-ray images such that the correction value can be used by the agricultural machine to calibrate the existing flow sensor. The controller may be further arranged to communicate with the agricultural machine to apply the correction value to all of the flow values measured by the existing flow sensor. When the agricultural machine includes at least one auxiliary sensor arranged to measure a respective flow value representative of a number of the desired particles in an associated flow of the particulate materials, the controller may be further arranged to communicate with the agricultural machine to apply the correction value to all of the flow values measured by the at least one auxiliary sensor.

The apparatus may further include a diverter arranged to divert a sample from the flow of the particulate materials through the agricultural machine to a sample area, in which the x-ray emitter is arranged to emit electromagnetic radiation through the particulate materials in the sample area, and (ii) an x-ray detector arranged to capture the electromagnet radiation emitted through the particulate materials in the sample area. The diverter may be operable between a diverting position diverting the sample from the flow to the sample area and an inoperative position in which the diverter does not interfere with the flow of the particulate materials through the agricultural machine.

When the agricultural machine includes an existing flow sensor arranged to measure a flow value representative of a number of the desired particles in the flow of the particulate materials, and the controller may be arranged to (i) acquire the flow value from the existing flow sensor, (ii) process the x-ray images to count a number of the desired particles in the x-ray images in the sample area, and (iii) calculate a correction value based on the flow value and the number of the desired particles counted in the x-ray images of the sample area such that the correction value can be used by the agricultural machine to calibrate the existing flow sensor.

The controller may be arranged to (i) record a sampling time when the sample is diverted from the flow of the particulate materials through the machine and (ii) associate the x-ray images of the sample generated by the x-ray imaging devices with the recorded sampling time. The diverter may be arranged to divert the sample from any selected one of a plurality of separate flows of the particulate material through the agricultural machine. The controller may be arranged to automatically operate the diverter to divert a sample from each of the separate flows at different times from other ones of the separate flows under programmable control. The diverter may comprise a material conveyor having a plurality of an intake gates arranged to be mounted on the agricultural machine in communication with the separate flows respectively, in which each intake gate is operable between respective open and closed positions under control of the controller.

When the agricultural machine us arranged to control operating characteristics of the agricultural machine according to a plurality of machine settings, the controller may be arranged to calculate a numerical value representing an amount of the interested particles for each associated one of a plurality of different configurations of the machine settings, and arranged to determine an optimal configuration of the machine settings based on the calculated numerical values and the associated machine settings.

The apparatus may further include a deep learning module trained on data acquired from the controller relating to the machine settings from agricultural machine and the calculated numerical values representing the amount of the interested particles in the flow of the particulate materials to determine the optimal configuration of the machine settings, in which the controller is arranged to instruct the agricultural machine to change the machine settings according to the determined optimal configuration.

The agricultural machine may comprise an agricultural seeding implement for seeding ground, in which the implement comprises (i) a seed tank for containing the particulate material in the form of seed therein, (ii) a plurality of ground openers arranged to form furrows in the ground, and (iii) a plurality of pneumatic distribution lines arranged to distribute the particulate material from the seed tank to the ground openers respectively. In this instance, the x-ray imaging device of the monitoring apparatus may be supported adjacent to the pneumatic distribution lines such that the numerical value calculated by the controller represents an amount of flow of the seeds in one or more of the distribution lines. The controller may be arranged to identify individual seeds as desirable particles and seeds clumps as undesirable particles. The controller may be arranged to compare the x-ray images to flow criteria and generate a notification to the user when one of the flow criteria has been met, in which the flow criteria correspond to a plug or a restricted flow in said one or more of the distribution lines. The controller may be arranged to generate instructions for a metering system of the implement to increase or decrease flow in one or more of the distribution lines responsive to the calculation of said numerical value representative of the amount of the interested particles identified in the flow.

### BRIEF DESCRIPTION OF THE DRAWINGS

Some embodiments of the invention will now be described in conjunction with the accompanying drawings in which:

FIG. 1 is a schematic representation of one embodiment of the agricultural monitoring apparatus according to the present invention;

FIG. 2 is a schematic representation of an agricultural harvesting machine upon which the apparatus is suitable to be installed;

FIG. 3 is a schematic representation of the installation of monitoring apparatus of FIG. 1 relative to the agricultural harvesting machine of FIG. 2;

FIG. 4 is a schematic view of a further embodiment of the monitoring apparatus applied to an agricultural harvesting machine;

FIG. 5 is a further embodiment of the monitoring apparatus applied to an agricultural harvesting machine;

FIG. 6 is a further embodiment of the monitoring apparatus applied to an agricultural harvesting machine; and

FIG. 7 is a further embodiment of the monitoring apparatus applied to an agricultural seeding implement.

In the drawings like characters of reference indicate corresponding parts in the different figures.

### DETAILED DESCRIPTION

Referring to the accompanying figures there is illustrated a harvest monitoring apparatus generally indicated by reference numeral 10. The apparatus 10 is particularly suited for use with an agricultural machine 12.

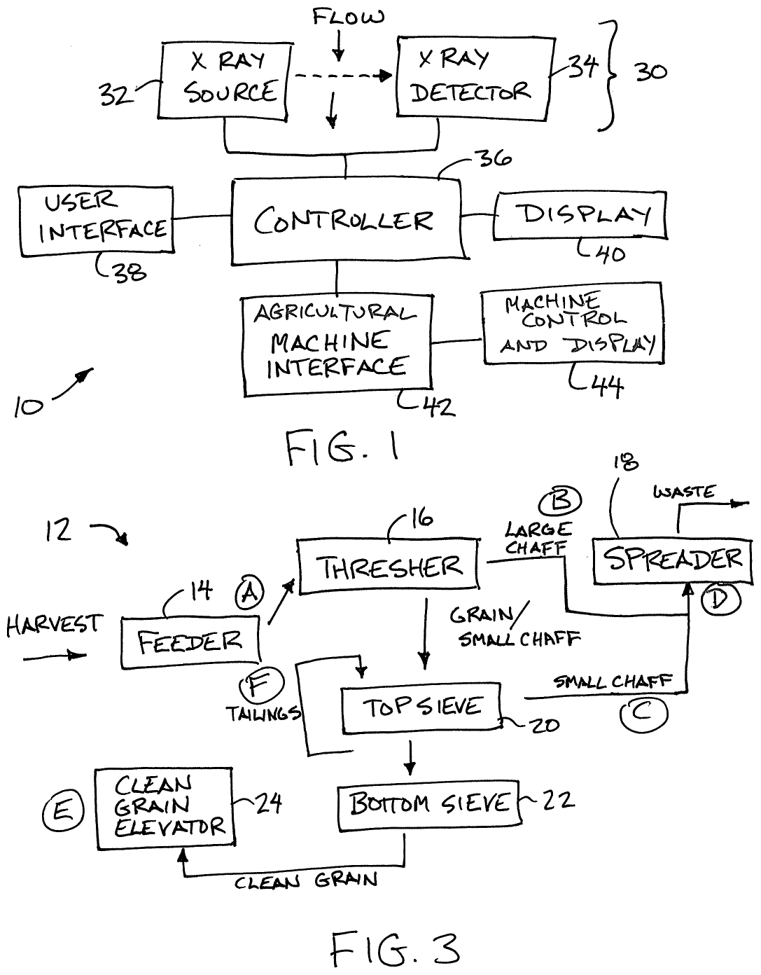

According to the embodiments of FIGS. 1 through 6, the agricultural machine 12 is a typical agricultural combine harvester including a feeder 14 for cutting and/or collecting crop from an agricultural field and feeding the crop into a thresher 16 of the machine. The thresher functions to thresh the harvested crop for separating the grain and some of the waste material including large chaff which is then discharged to a spreader 18 of the machine. Grain and small chaff pass through the thresher to a grain cleaner including a top sieve 20 and a bottom sieve 22. Some of the small chaff is removed from the top side of the top sieve 20 to be redirected to the spreader 18. The partially cleaned grain passing through the top sieve 20 to the bottom sieve 22 is further processed to remove a tailings flow from the top side of the bottom sieve 22 which is returned to the top side of the top sieve 20. Cleaned grain passing through the bottom sieve 20 is directed to a clean grain elevator 24 that conveys the clean grain to a seed tank of the machine 12. The machine 12 further includes a control system with the various sensors capable of estimating yield and the like.

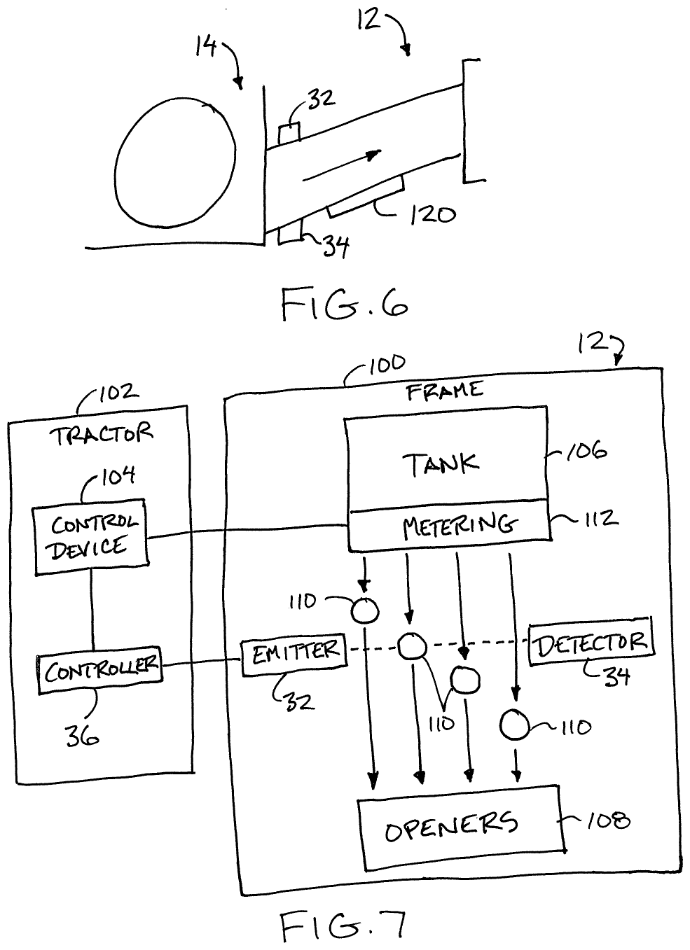

According to the embodiment of FIG. 7, the agricultural machine 12 may be an agricultural seeding implement. The seeding implement typically comprises a frame 100 supported for movement across the ground when towed by an agricultural tractor 102. The agricultural tractor 102 includes a computer control device 104 which controls the various operations of the tractor and which communicates with the seeding implement to control various operating characteristics of the seeding implement as well. The seeding implement includes a tank 106 for containing particulate material, for example seed therein. A plurality of openers 108 are supported on the frame for forming respective furrows in the ground as the implement is towed across the ground. A plurality of pneumatic distribution lines communicate between the tank 106 and the openers 108 respectively for communicating the particulate material from the tank to the openers for delivery into the ground. A metering apparatus 112 controls the metering of the particulate material into the individual distribution lines 110. Operating characteristics relating to the fan speed of the pneumatic distribution system, the metering of individual distribution lines, and other operating characteristics of the implement may be controlled by the computer control device 104. The apparatus 10 is typically mounted in proximity to the pneumatic distribution lines 110 for measuring the amount of material flowing in one or more of the distribution lines, as well as identifying a plug or reduced flow in the lines, or clumping of the particulate material flowing in the lines, as described in further detail below.

The apparatus 10 can be mounted at one or more locations within the agricultural machine 12 to monitor one or more flows of material through the agricultural machine 12. In each instance the apparatus 10 generally includes an x-ray imaging device 30 including an x-ray emitter 32 arranged to emit electromagnetic radiation as a beam directed through a designated flow of material through the machine 12 with which the device 30 is associated. The x-ray imaging device 30 also includes an x-ray detector 34 mounted in proximity to the emitter 32 to receive the electromagnetic radiation beams emitted by the emitter 32 and passed through the designated flow of material through the machine. The detector 34 is further configured to generate an x-ray image based on the data acquired from the electromagnetic radiation captured by the detector 34. When mounted in association with a continuous flow of material through the machine, the x-ray imaging device 30 captures a continuous series of x-ray images over time as a time series set of x-ray images at consecutive points in time. The imaging device 30 may be further arranged to process the x-ray image data to identify particles or objects within the designated flow of material.

The apparatus 10 further comprises a controller 36 in the form of a computer controller having a memory storing program instructions thereon and a processor for executing the programming instructions to perform the various functions of the controller described herein. In general, the controller 36 functions to process the x-ray images generated by the x-ray imaging device. Each x-ray image may comprise x-ray image data in the form of an array of pixels having varying values representing varying contrast or brightness proportional to the density of the material that a corresponding portion of the electromagnetic radiation passes through.

In one embodiment, the x-ray images may be processed to identify boundaries between high and low contrast areas corresponding to high and low densities within the flow such that the identified boundaries define object boundaries of prescribed shape. The boundary shapes can be identified by the controller and compared for similarity to known shapes stored on the controller that are associated with the identification of seed or grain particles, or the identification of non-grain particles. In some instances, if the boundary shape does not match a known particle shape stored on the controller, the shape may be determined to be a non-desirable particle.

Known particle shapes may include intact seeds or grains or damaged seeds or grains. The controller may be further arranged to distinguish between intact and damaged particles.

In another instance, the controller may process the images to identify clusters of high-density pixels within a prescribed density pattern such that the identified density patterns are compared to stored density patterns associated with known intact grains, known damaged grains or non-grain particles for example. By performing a similarity comparison between identified density patterns within the x-ray image data and known density patterns stored on the controller, various determinations regarding the identity of the objects or particles within the x-ray image data can be made.

The controller may also make use of a deep learning detection module trained on numerous prior x-ray images of relevant particles that are known to be desired particles such as seeds or grains or non-desired particles such as debris, waste material or undesired clumping of materials, so that the detection module can detect or identify relevant particles in the images of the flow and then determine if the particles are desirable or non-desirable particles.

According to a further instance, the controller may use a technique called diffraction enhanced imaging. In this case, the sources come in two broad categories fixed and rotating targets, with two energy ranges in the KV and MeV range of outputs. For Mev range, the source would be a linear accelerator or Linac for short. For the detector there may be curved arrays, linear arrays and flat panels.

The apparatus 10 further includes a user interface 38 enabling an operator to input data into the apparatus including commands or requests for information of a prescribed type. In one example, a touchscreen may be provided that responds to user input. Alternatively, the user interface may take the form of a wired or wireless connection to a personal computer device of the operator such as a tablet to enable data to be input into the apparatus 10 or requested to be output to the user computer device. Instructions can include varying the programming configuration or varying the operating mode or an operating condition of the apparatus 10 as selected by a user. The apparatus 10 also includes a display 40 for displaying data of various types or any calculated values or ratios to the operator. In the instance of the user interface comprising a touchscreen, the same touchscreen may function as the display for displaying data to the operator.

In some instances, operation of the apparatus 10 may be controlled by the operator through controls of the harvesting machine by use of a harvesting machine interface 42 that allows the controller 36 of the apparatus 10 to communicate with a corresponding computer control device 44 of the harvesting machine. The computer control device 44 is a computer controller that is arranged to control operating characteristics of the agricultural machine according to machine settings which are arranged to be programmed in different configurations to vary the operating characteristics of the machine. In this instance, information may instead be displayed to the operator through a corresponding display of the computer control device 44 of the harvesting machine. Likewise commands and selections made by the operator to control operation of the apparatus may be delivered to the controller through operator controls of the harvesting machine that communicate through the harvesting machine interface 42. The machine interface 42 also allows the controller to acquire various data from the agricultural machine including yield data determined by a harvesting machine, or various machine performance conditions including speeds or flow rates of various forms associated with the agricultural machine.

The apparatus 10 can include a plurality of x-ray imaging devices mounted at various locations, each with their own respective controller 36 as described above. Alternatively, a plurality of x-ray imaging devices can be mounted at various locations so as to be in communication with a common controller 36 that processes the data from various locations and communicates the data collectively for display to the operator through a dedicated display 40 or through the existing display 44 of the agricultural machine through the machine interface 42.

According to FIGS. 1 through 6, the agricultural machine in these instances is an agricultural combine harvester 12.

In one instance, an x-ray imaging device 30 is located at a first location A in proximity to the feeder 14 for monitoring a flow of harvested materials passing through the feeder towards the thresher. The device in this instance is arranged for identifying and counting grain particles in the flow as well as non-grain particles within the flow. The x-ray imaging device 30 may be further arranged for identifying foreign debris above a certain threshold size. The counted grain particles can be used to calculate a harvested value representing the total number of grains which are collected by the machine 12 before any separation and cleaning occurs.

An x-ray imaging device 30 may be also mounted at location B after some separation of materials has occurred in the thresher 16. In particular a thresher waste flow of materials separated from the grain by the thresher and being directed towards the spreader 18 is scanned and grain particles are identified in the flow and counted to determine the amount of grain being lost in the thresher waste flow.

Similarly an x-ray imaging device 30 can be mounted at location C after some separation of materials has occurred in the grain cleaner. In particular a grain cleaner waste flow of materials separated from the grain by the top sieve 20 of the grain cleaner and being directed towards the spreader 18 is scanned and grain particles are identified in the flow and counted to determine the amount of grain being lost in the grain cleaner waste flow.

An x-ray imaging device 30 can also be mounted at location D after the thresher waste flow and the grain cleaner waste flow described above are combined before the spreader 18. Again in this instance, the x-ray imaging device functions to count identified grain particles within the combined flow to determine the amount of grain being lost by the grain cleaner and the thresher combined.

An x-ray imaging device can also be mounted at location E corresponding to the clean grain elevator 24. The device 30 in this instance scans and monitors a clean grain flow at any location within the clean grain elevator for both identifying and counting grain particles to calculate a yield value and identifying and counting non-grain particles to calculate a dockage value.

Finally, an x-ray imaging device may be located at location F in association with a tailings elevator for scanning and monitoring a tailings flow from the bottom sieve to the top sieve of the grain cleaner. The x-ray imaging device in this instance counts both grain and non-grain particles within the flow.

Using any combination of the above x-ray imaging devices 30 together with data acquired from the harvesting machine, for example yield data determined by the harvesting machine, the controller can further calculate various numerical values indicative of the performance of various material separation stages of the harvesting machine 12.

The controller may be further arranged to calculate various ratios that may be useful to the operator. For example, any of the calculated values relating to lost grain in the thresher waste flow, the cleaner waste flow or the combined waste flow can be expressed as a ratio relative to a yield value to determine grain loss as a percentage of yield. The yield value may comprise an estimate of the yield based on the count of identified grain particles in the feeder flow, an estimate of the yield based on the count of identified grain particles in the clean grain flow, or an estimate of yield determined by the harvesting machine using existing sensing devices of the harvesting machine.

Total grain lost throughout the harvesting process can also be determined by calculating a difference between the yield of identified grain particles in the feeder flow at the feeder 14 and the yield of identified grain particles in the clean grain flow at the clean grain elevator 24.

The dockage value calculated above can also be expressed as a ratio relative to any of the yield values discussed above.

The apparatus as described herein may function as a loss monitoring system that is attached to an agriculture harvester made up of an x-ray source paired with an x-ray detector that can detect, image, count, and/or weigh the amount of seeds that are lost through the harvesting process. With the data collected, being able to input the loss data into a display for easy operator evaluation and/or paired with or in tandem with a yield monitor display that would give the operator a percentage of total loss in relation to the yield of the harvested crop.

The x-ray source and x-ray detector may also be mounted in such a way on an agriculture harvester that it can detect and image, count, and/or weigh the amount of seeds and or straw material that is going into the separation area of the harvester and the data then can be used to predict yield, combine speed and/or performance settings. This said data can also be used to compare with the harvester loss monitoring data and also give a percentage of loss relevant to the predicted yield.

This described grain loss detection system could also be mounted in such a way to detect the clean grain going into the harvester grain tank and be used to count seeds and or straw to predict yield and/or loss and of foreign material that could be described as dockage.

This described detection system could also be mounted in such a place it could measure the amount of seeds and/or straw in the tailings system of the harvester.

Among the optional configurations of the apparatus 10, the apparatus could be configured in a first iteration so as to be placed in the area of the thresher or in any other suitable place that is after the combine header and before the threshing area. This system would collect data of the total grain coming into the combine indicated by the dark green on the image. The system would collect data in the form of, but not limited to, seed counts, seed density, seed weight. The system also could possibly be used to detect a foreign object such as a rock or any other thing that could damage the combine. This data would all then be sent to a processing device.

According to a second iteration of the apparatus 10, the apparatus could be placed in a suitable area after the discharge beater or in any other area after the main threshing and separation is done to detect the losses coming off the rotor/cylinder and main threshing area. According to a further iteration, the apparatus 10 could also be placed in a suitable area after the shoe/sieves and cleaning of grain area. These systems would collect data and process it in the form of, but not limited to seed counts, seed density and seed weight. This stream is shown by the lime green in the image. Alternatively, you could place an x-ray source and detector in a suitable place after both the threshing and cleaning areas that would be able to detect all losses going out the back of the combine. This data would all then be sent to a processing device.

According to a further iteration of the apparatus 10, the apparatus can be placed on the clean grain elevator such that the x-ray and detector system could detect density, count and/or weight of the clean grain flow. This system could also be put anywhere on the clean grain elevator. It could also detect the weight of foreign material that is not seeds and could be called dockage in the clean grain. This data would all then be sent to a processing device.

According to another iteration, the apparatus 10 could be placed in proximity to the tailings elevator so that the x-ray and detector system could detect density, count and/or weight of the seeds. This system could also be put anywhere on the tailings elevator. It could also detect the number of seeds and foreign material. This data would all then be sent to a processing device.

The data that is collected off the clean grain elevator or the tailings elevator could be displayed on a monitor as a percentage difference in weight of grain and foreign material that flows through the clean grain and the tailings elevators so that the operator or combine automation can see and change the combine settings accordingly.

When mounted on the clean grain elevator, the apparatus 10 could also be used to count seeds and or weigh and be used as an accurate yield and clean grain tank level predictor. This accurate yield monitoring can also be used with the loss monitoring systems to get an accurate percentage difference.

The processed data then can be sent to the appropriate display and or function of the combine.

In the case of loss monitoring, the data collected from the thresher waste flow or the grain cleaner waste flow would be sent to a display that could show losses in seed counts per time interval, bushels an acre, or bushels an hour or any other preset parameter. There could be software programmed to show unthreshed grain as well as size the seeds. The display could show thresher loss and shoe loss individually and or combined for total losses. Alternatively, you could just have a system that would show total loss all together all the time.

The described loss monitoring could be combined and enhanced by taking the data from the monitoring of the feeder flow showing the count of seeds coming into the combine by different parameters preset or set by operator such as, but not limited to, seeds per second, or any time interval, bushels per hour, weight or density. This data collected would then be compared to the loss monitoring systems of any of the thresher or grain cleaner waste flows on the back of the combine that was set to the same parameters the monitoring of the feeder flow. This could then be displayed ether remotely or in the combine cab to the operator in the form of a percentage difference between seeds/bushels coming in and seeds/bushels lost out the back discharge stream.

Alternatively, loss systems that monitor the thresher and/or grain cleaner waste flows could also be combined with current harvester yield monitoring system to give a rough idea of losses relative to yield.

Another possible use of waste flow monitoring is to have a powerful enough source that could render the seeds going out the back of the combine incapable of growing. This would be very nice to stop from spreading weeds and seeds to grow again.

An added benefit of monitoring the feeder flow is that the system could also be programmed to see rocks or any other bigger foreign objects above a set threshold size and send signals to the combine processors to shut off the combine before more damage occurs.

In further embodiments, the data collected from the different x-ray arrangement locations could be used to average out the lost grain over an amount of time with previous combine settings and compare that with current combine settings. It could store these combine settings in a database and rank them according to the fewest losses to help the operator select the best optimized settings.

The same principles stated above could also be used in a manner but with the data collected from the feed area and/or clean grain elevator and/or the tailings elevator sensors. The clean grain elevator and tailings elevator sensors could sense the amount of foreign materials in the samples in relation to the seeds, and/or undesirable characteristics such as cracked seeds or unshelled material and store that in the database as well. The sensor in the feed area could be collecting crop condition data coming into the harvester such as but not limited to straw moisture, seed moisture, and crop density and store it in the same database. Then using any of the collected data, combined or separate, the operator or computer could find the most optimized combine settings with the fewest losses and/or the cleanest threshed grain sample. The system could also store this data to help the operator find optimized combine settings when the system detects similar harvesting conditions to the previously collected data.

Optionally, the system may be further provided with split detectors that could sense the combine feeding one side more than the other or it could detect if the combine has more lost seeds on one side or the other. In a further embodiment, the system could have 3 detectors and sense the losses on the right, middle, and left of the combine.

This x-ray device might also apply the captured images to suitable image processing models that are able to detect certain characteristics of the seeds that might be helpful for the combine computer or operator to know such as oil content, proteins, discoloration, immature seeds, or any other aspect of the seeds in the flow of crop.

Turning now to the embodiment of FIG. 6, when the apparatus 10 is specifically mounted in proximity to the feeder 14 or generally in the front feeder area, the controller 36 may be specifically configured to distinguish harvested materials including grain and waste materials from debris in the form of larger foreign objects such as stones, metal or other debris objects that could cause damage to the combine harvester. In this instance, the controller may communicate with a suitable ejector 120 that serves to eject the detected debris object from the harvested materials. In one example, the ejector 120 may be a trap door under the feeder floor that can automatically open when triggered by the detection apparatus to let the harmful objects be ejected from the harvested materials by falling onto the ground. In yet further instances a deflector or outside force such as a jet of compressed air may be used to actively push or eject the identified debris object.

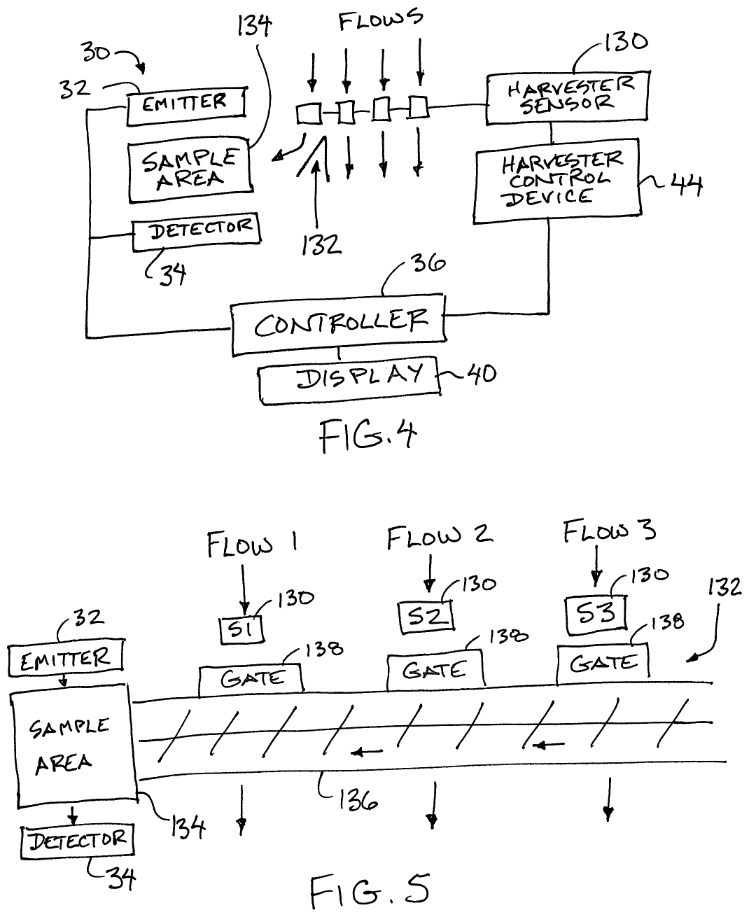

As shown in FIGS. 4 and 5, the apparatus 10 may be used to monitor a flow of particulate materials that is otherwise already monitored by existing flow sensors 130 of the agricultural machine. In one example the existing flow sensor 130 is an impact type yield monitor that estimates the amount of grain in a flow by the forces impacting the yield sensor. A similar sensor may be placed in the waste flows to monitor impacts of seed on the existing sensor 130 to detect seeds in the waste flow. In these instances, the apparatus 10 may include a diverter 132 which communicates with the flow in proximity to the existing flow for diverting a sample portion of the flow to a separate sampling area 134 located on the agricultural machine. The emitter 32 and the detector 34 of the x-ray imaging device 30 in this instance are positioned on opposing sides of the sample area 134 to direct the x-rays through the material in the sample area for measurement. The controller then operates in the manner described above for identifying particles in the sample area and then distinguishing between desirable and undesirable particles for counting.

When diverting a portion of the flow to a separate sampling area 134, the controller is arranged to record the time of the flow when the diverter was activated while also recording corresponding machine settings and the readings from the existing flow sensor 130 at the same time. The recorded time is associated with the x-ray images subsequently captured at the sample area for the sample of particles that was diverted at the recorded time. Subsequent calculation of a yield value for example can then be correlated with the corresponding value measured by the existing sensor 130 of the agricultural machine. By comparing the measurements, the controller can further calculate a calibration or correction value to be applied to the measured value of the flow sensor 130 to correctly calibrate the measured value to the actual value detected by the apparatus 10.

With reference to FIG. 4 specifically, the diverter 132 in this instance may comprise a baffle or chute that can be moved into active engagement with any selected one of a plurality of separate flows having separate existing sensors 130 associated therewith. The selected flow is actively engaged by the diverter in a working position to divert a sample from the selected flow into the x-ray imaging device 30. The controller 36 in this instance communicates with the computer control device 44 of the harvesting machine to acquire the measured values from the existing flow sensors 130 for subsequent comparison and calculation of the correction value. The correction value can be displayed on a display 40 associated with the apparatus 10 or on the existing display associated with the control device 44 of the agricultural machine. This process is repeated for each flow being monitored. In some instances, the correction value calculated in association with one of the existing sensors 130 can be applied as a correction value for measured results from all of the other existing sensors of the machine. Alternatively the controller can be arranged to individually divert each flow to the imaging device 36 to calculate a correction value that is specific to the selected flow and the existing flow sensor 130 associated with that flow so that each sensor can be calibrated with its own correction value.

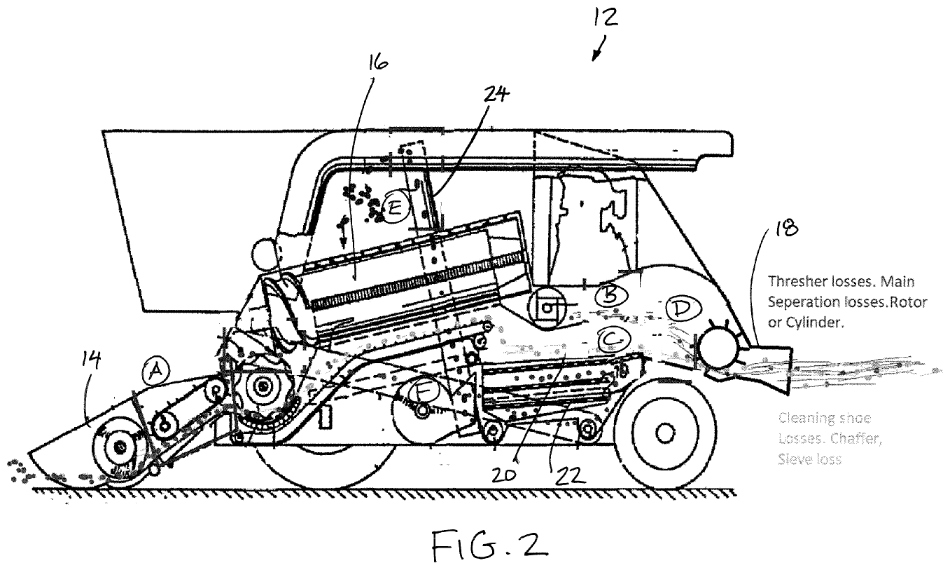

As shown in FIG. 5, the diverter may instead comprise a conveyor 136 which may comprise a single auger or belt conveyor, or a series of individual augers and belt conveyors connected end to end with one another to collectively define a conveyance path. The conveyor 136 includes a plurality of intake gates 138 associated therewith so that material introduced into the conveyor 136 from any one of the gates 138 results in the particulate material introduced to the conveyor being conveyed to the separate sampling area 134 where the imaging device 30 is again provided. Each intake gate 138 may be associated with a different flow within the combine such as any of the flows A, B, C, D, E or, F noted in FIGS. 2 and 3 for example. To perform an analysis of any one of the flows, the corresponding gate is opened to introduce a sample from the selected particulate material flow into the conveyor for subsequent measurement and analysis at the imaging device 30. Depending upon the selected flow, the controller can be operated in different modes to detect undesirable particles within a clean flow of desired particles or detect desired particles within a waste flow of undesired particles as described above.

In either instance, the diverter 132 is operable between a diverting position diverting the sample from the flow to the sample area and an inoperative position in which the diverter does not interfere with the flow of particular materials through the agricultural machine. Likewise, and either instance the controller operates to acquire measured flow values from the existing flow sensors 130 followed by processing of the x-ray images to count the number of the relevant particles in the x-ray images within the sample area so that a correction value can be calculated based on the sensor values and the counted particles in the sample area. The correction value can be used by the agricultural machine to calibrate the existing flow sensors.

The correction value could be in a different metric. For example, if applying a correction value in the form of weight being scanned there could then be displayed on the monitor the weight of seeds. The operator could then choose if they wanted that weight displayed in bushels or lbs an acre or in dollars an acre.

The apparatus could be further arranged to collect different data characteristics including but not limited to, the amount of seeds in the portion of material flowing over an area represented by one of the existing or an installed harvester sensor and use the accurate data determined by the apparatus 10 to come up with a correction value between the total accurate data determined by the apparatus 10 and the sensors on the harvester. Then using the correction value determined by the difference of the accurate apparatus data and harvester sensors, apply it to the remaining harvester sensors to determine an accurate total loss. The apparatus could then be controlled by a controller, manually or in a different way to be moved to different material flows or different portions of the same material flow represented by installed harvester sensors and can use the same principle described to correct all of the harvester sensors.

The apparatus could also then be used to accurately measure the grain or other characteristics of the material flow in different harvester areas that are represented by different manufacturer supplied sensors and/or monitors or third party installed sensors and/or monitors, and apply an accurate correction value to those sensors and/or monitors.

There could also be arranged one or more said apparatuses 10 on the combine in stationary or mobile spots throughout the harvester and a separate apparatus could be made to divert different material flows to these one or more apparatuses to measure one area for a set time period then apply a correction value. After the set time period is over, the material flow from another area could be diverted to said apparatus and measured for a time period and corrections applied. This way you could possibly measure numerous different material flows with fewer apparatuses.

The apparatus 10 could also be arranged in such a way that grain or crop flow would be captured in a separate area or storage device 134 and then from the device 134 the apparatus 10 would scan different characteristics of the grain or crop flow and display the information. This information captured would be more accurate than the existing sensors on the harvester machine and so can then be used to continuously or periodically capture and scan the crop flow. The data collected could be used to apply a correction value to the existing sensors for more accurate readings, or as a stand-alone monitoring device.

As described above, the apparatus 10 can also divert a portion of the material flowing through the combine to a set place for scanning using a diverter 132. The diverter 132 separates a portion of material flow to a sampling area 134 for easy measuring. For instance, the diverter 132 could divert the straw that is flowing over one of the loss sensors that are spread across or throughout the combine, and gain a measurement of the material characteristics including seeds, and use the measurement to correct the existing or installed harvester monitors. This apparatus could be placed in such a way that it would take a portion of any of the material flow and divert it to a common sampling area 134 for measurement.

The diverter could consist of (i) just a shaker pan to shake a sample of particles off to the side for measurement, (ii) a spinning wheel that grabs straw and directs it to the side for measurement, (iii) a spinning wheel that the straw drops onto and directs it to a measurement area, or (vi) a series of deflectors that direct it away from the main flow to the scanner or to an auger that augers it to a scanner or to a belt that conveys it to the scanner.

As shown in FIG. 5, an auger running across the machine from side to side can have trap doors 138 that slide or open in some way so that different portions of the material flow could drop into or be diverted into the auger 132. The scanning apparatus 10 would then be located at the end of the cross auger to accurately scan the material and apply a correction value.

In another instance a set time period of material flow could be collected in any of the crop flow areas of the harvester and put it in a separate area 134 for measuring. In one instance the diverter 132 would direct the flow of clean grain into a separate compartment. The combine would have measured this flow through its mass flow vibration sensors or other flow sensors. The software of the controller 36 would remember that sensors readings for the time period of separating off the flow. The separate flow that is collected would then be accurately measured with a source and detector or another method to determine an accurate reading of the captured flow. The controller would then use the accurate reading to update and set a correction value to the existing crop flow sensors. This accurate measurement apparatus could also be able to collect data like the amount of foreign material in the flow vs the seeds or other characteristics and use that information to set the combine or display that information in a format that the operator could make changes if so desired.

This same principle could be applied to different flow areas in the combine, for example the tailings system, and the controller 36 could detect unthreshed seeds or too many seeds and other characteristics in the tailings system.

Detection may also consist of individually identifying non desired material or desired material such as but not limited to seeds. The object of interest can be detectable as single individual items that can be counted of an area density and can be defined to distinguish regions of material such as seed clumps.

Artificial intelligence such as deep learning modules can be used to observe and deduce patterns of machine setup changes and resulting material patterns in the stream of material being imaged. This can lead to algorithm development and/or optimization over time specific to the machine and region the combine is used. It could also be used to develop algorithms for different machine setups based on the different characteristics of the material scanned. A controller could then be used to adjust combine settings based on the AI generated data.

When the agricultural machine comprises either a combine harvester or a seeding implement controlled by a control device of an associated towing tractor, in each instance the agricultural machine is arranged to control operating characteristics according to a plurality of machine settings. When the controller 36 calculates an amount of specified desired or undesired particles among the particles of one or more flows of the agricultural machine, the controller also acquires the corresponding machine settings at the sampling time. Various collected data relating to the identified particles within the sampled flows and the corresponding machine settings can all be stored as correlated data used in training a deep learning module. The module can then be applied to new flows to generate optimal recommendations regarding the machine settings to minimize the amount of desired particles such as seed within waste flows and minimize the amount of undesirable particles such as waste within cleaned seed flows. In the instance of a combine harvester, the machine settings can relate to operating characteristics relating to the feeder, the thresher, the sieves, and/or the spreader for example.

In some instances, the controller may include a local processing component on the agricultural machine and a separate computer server at a remote location that communicates with the local controller over a suitable communications network. Any collected data from multiple different apparatuses 10 operating on different machines 12 can commonly report over the communications network back to the central server for use in better training the deep learning module. Trained detection models can then be generated for communication back to the controller such that the detection module operating on the controller can generate optimal recommendations for ongoing use of the machine based on data from that machine or other machines. The controller 36 may also be arranged to generate instructions for the agricultural machine to change the machine settings according to the determined optimal configuration.

A similar arrangement of data reported back to a central server for training a deep learning detection module can also be performed for improving the accuracy of the desired and undesired particle detection module. The trained detection module can then be reported back to the controller for use in distinguishing between desired and undesired particles when calculating the amount of interested particles in the sample flows.

Turning now more particularly to FIG. 7, when used on an agricultural machine comprising a seeding implement, the imaging device 30 is typically used for monitoring flows in the pneumatic distribution lines. The imaging device 30 may scan multiple distribution lines at the same time. Alternatively, the emitter 32 and the detector 34 may be controllably displaced between different operating positions in which the emitter and detector are provided on opposite sides of a selected one of the distribution lines 110 at each operating position. The controller 36 may control positioning of the emitter and detector such that the controller may choose to perform a measurement at each flow line at a programmably scheduled time to cycle the flow measurements between all of the different flow lines on an ongoing periodic basis.

The apparatus 10 can also be used to calibrate the metering system so that a flow measurement can be taken corresponding to a number of identified particles within a prescribed flow area for a prescribed duration for comparison to the intended flow amount based on the machine settings for the metering system. By comparing the machine settings for the metering system with the measured amounts by the controller 36 processing the images from the imaging device 30, a correction value can be calculated for calibrating the settings of the metering system. The controller 36 may also be arranged to generate instructions for the metering system of the agricultural machine to increase or decrease flow in a corresponding distribution line in response to calculation of a value representing flow in a monitored line that indicates the identified particles in the flow are below or above the intended metering rate.

When applied to a seeding implement, the apparatus 10 may be arranged to identify individual seeds as desirable particles, whereas seed clumps may be identified as undesirable particles. The controller 36 may also compare the x-ray images to flow criteria stored on the controller such that a notification for delivery to the user may be generated when the flow criteria has been met. The flow criteria make comprise a lower threshold corresponding to a plug or a restricted flow in any distribution line being monitored.

The apparatus could also be used in other equipment such as on an agriculture seeding device and could then be used to detect the flow of seeds or material in the seed tubes or different areas of the seeding device. It could be used to detect flow and or detect amount of flow including but not limited to density flows, seed counts, or different characteristics.

There could be numerous apparatuses 10 throughout the seeding implement to detect flows and or characteristics of different streams throughout the seeding machine. A display 40 could be arranged to show the data collected to the operator of the seeding device to show if one of the flows is plugged or has restricted flow. It could display the individual hoses and the data of a sensor on each hose to determine if there is a problem with the seeding machine. It could also be in an interface programmed to help the seeding machine achieve different tasks such as but not limited to applying more or less flow, seeds or material down different hoses. This may be useful when the seeding machine is turning and the inside of the machine needs to apply less because it is going slower and the outside of the machine should apply more because it is going faster to get an even seed distribution across the seeding machine.

Since various modifications can be made in the invention as herein above described, and many apparently widely different embodiments of same made, it is intended that all matter contained in the accompanying specification shall be interpreted as illustrative only and not in a limiting sense.

1. A monitoring apparatus for an agricultural machine for handling flowable particulate materials, the apparatus comprising:
an x-ray imaging device arranged to be supported on the agricultural machine in proximity to a flow of the particulate materials passing through the agricultural machine, the x-ray imaging device including (i) an x-ray emitter arranged to emit electromagnetic radiation through the particulate materials from the flow, and (ii) an x-ray detector arranged to capture the electromagnet radiation emitted through the particulate materials from the flow by the x-ray emitter for generating x-ray images of the particulate materials from the flow; and
a controller in communication with the x-ray imaging device, the controller comprising a memory storing programming instructions thereon and a processor arranged to execute the programing instructions so as to be arranged to (i) process the x-ray images from the x-ray imaging device to identify interested particles comprising desirable particles or non-desirable particles within the particulate materials of the flow, (ii) calculate a numerical value representing an amount of the interested particles identified in the particulate materials of the flow, and (iii) display the numerical value to an operator of the agricultural machine.

2. The apparatus according to claim 1 wherein the controller is arranged to identify the particles in the x-ray images using contrast changes to define object boundaries and comparing similarity between shapes of the object boundaries and predetermined particle shapes stored on the controller, the predetermined particle shapes being representative of known particle types.

3. The apparatus according to claim 1 wherein the controller is arranged to identify the particles in the x-ray images by comparing density patterns in the x-ray images to predetermined density patterns stored on the controller, the predetermined density patterns being representative of known particle types.

4. The apparatus according to claim 1 wherein the agricultural machine comprises an agricultural harvester and the flow of the particulate material comprises a flow of harvested materials including grain and waste materials and wherein the controller is arranged to process the x-ray images such that the desirable particles comprise grain particles and the non-desirable particles comprise non-grain particles.

5. The apparatus according to claim 4 wherein the x-ray imaging device is arranged to be supported on the agricultural machine such that the flow of the particulate materials comprises a separated flow of the waste materials separated from the grain, and wherein the controller is arranged to identify the desirable particles in the separated flow such that the numerical value represents the amount of desirable particles lost in the separated flow.

6. The apparatus according to claim 5 wherein the separated flow comprises a tailings flow separated from a lower sieve of a grain cleaner of the agricultural machine.

7. The apparatus according to claim 5 wherein the separated flow comprises a thresher waste flow separated from a thresher of the agricultural machine.

8. The apparatus according to claim 5 wherein the separated flow comprises a cleaner waste flow separated from an upper sieve of a grain cleaner of the agricultural machine.

9. The apparatus according to claim 5 wherein the x-ray imaging device is further arranged to be supported on the agricultural machine such that the flow of the particulate materials further includes a clean grain flow of cleaned grain from which waste materials have been separated such that the controller is arranged to calculate a yield value representing harvested grain, the controller being further arranged to calculate grain loss as a ratio between the numerical value of grain particles in the separated flow and the yield value calculated by the controller to represent the harvested grain.

10. The apparatus according to claim 5 wherein the x-ray imaging device is further arranged to be supported on the agricultural machine such that the flow of the particulate materials includes a feeder flow of the particulate materials from a feeder of the agricultural machine such that the controller is arranged to calculate a harvested value representing harvested grain, the controller being further arranged to calculate grain loss as a ratio between the numerical value of grain particles in the separated flow and the harvested value calculated by the controller to represent the harvested grain in the feeder flow.

11. The apparatus according to claim 4 wherein the x-ray imaging device is arranged to be supported on the agricultural machine such that the flow of the particulate materials comprises a clean grain flow of cleaned grain from which waste materials have been separated and wherein the controller is arranged to identify the grain particles in the clean grain flow such that the numerical value represents an observed yield value of the agricultural machine.

12. The apparatus according to claim 11 wherein the controller is arranged to (i) acquire a calculated yield value from the agricultural machine and (ii) calculate a similarity between the observe yield value and the calculated yield value from the agricultural machine.

13. The apparatus according to claim 4 wherein the x-ray imaging device is arranged to be supported on the agricultural machine such that the flow of the particulate materials comprises a feeder flow of the particulate materials from a feeder of the agricultural machine and wherein the controller is arranged to identify the grain particles in the feeder flow such that the numerical value represents a harvested yield value of the agricultural machine.

14. The apparatus according to claim 13 wherein the x-ray imaging device is further arranged to be supported on the agricultural machine such that the flow of the particulate materials further includes a clean grain flow of cleaned grain from which waste materials have been separated in which the controller is arranged to identify the grain particles in the clean grain flow and calculate a second numerical value that represents a clean grain yield value of the agricultural machine, the controller being further arranged to calculate grain loss as a difference between the harvested yield value and the clean grain yield value.

15. The apparatus according to claim 13 wherein the x-ray imaging device is further arranged to be supported on the agricultural machine such that the flow of the particulate materials further includes a separated flow of waste materials separated from harvested grain in which the controller is arranged to identify the grain particles in the separated flow and calculate a second numerical value that represents an amount of lost grain particles in the separated flow, the controller being further arranged to calculate grain loss as a ratio of the amount of lost grain particles to the harvested yield value.

16. The apparatus according to claim 4 wherein the x-ray imaging device is arranged to be supported on the agricultural machine such that the flow of the particulate materials comprises a clean grain flow of cleaned grain from which waste materials have been separated, and wherein the controller is arranged to identify the non-grain particles in the clean grain flow such that the numerical value represents the amount of non-grain particles remaining in the clean grain flow.

17. The apparatus according to claim 1 wherein the agricultural machine includes an existing flow sensor arranged to measure a flow value representative of a number of the desired particles in the flow of the particulate materials, and wherein the controller is arranged to (i) acquire the flow value from the existing flow sensor, (ii) process the x-ray images to count a number of the desired particles in the x-ray images, and (iii) calculate a correction value based on the flow value and the number of the desired particles counted in the x-ray images such that the correction value can be used by the agricultural machine to calibrate the existing flow sensor.

18. The apparatus according to claim 1 further comprising a diverter arranged to divert a sample from the flow of the particulate materials through the agricultural machine to a sample area, wherein the x-ray emitter is arranged to emit electromagnetic radiation through the particulate materials in the sample area, and (ii) an x-ray detector arranged to capture the electromagnet radiation emitted through the particulate materials in the sample area.

19. The apparatus according to claim 1 wherein the agricultural machine is arranged to control operating characteristics of the agricultural machine according to a plurality of machine settings, wherein the controller is arranged to calculate a numerical value representing an amount of the interested particles for each associated one of a plurality of different configurations of the machine settings, and wherein the controller is arranged to determine an optimal configuration of the machine settings based on the calculated numerical values and the associated machine settings.

20. The apparatus according to claim 1 wherein the agricultural machine comprises an agricultural seeding implement for seeding ground, the implement comprising (i) a seed tank for containing the particulate material in the form of seed therein, (ii) a plurality of ground openers arranged to form furrows in the ground, and (iii) a plurality of pneumatic distribution lines arranged to distribute the particulate material from the seed tank to the ground openers respectively, and wherein the x-ray imaging device of the monitoring apparatus is supported adjacent to the pneumatic distribution lines such that the numerical value calculated by the controller represents an amount of flow of the seeds in one or more of the distribution lines.
